(19) United States
(12) Patent Application Publication
(10) Pub. No.: US 2007/0022560 A1
(43) Pub. Date: Feb. 1, 2007

(54) Central vacuum system and method for treating the system

(76) Inventors: William David Corwin, Clive, IA (US); Lisa Marie Corwin, Clive, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/190,655

(22) Filed: Jul. 27, 2005

(51) Int. Cl. A47L 5/38; B08B 9/04

(52) U.S. Cl. 15/314; 15/104.061

(57) ABSTRACT

A method and device for treating a central vacuum system is provided for cleaning, deodorizing, disinfecting, adding fragrance and/or removing static electricity from the tubing network of the vacuum system. The treatment device is a cloth or other object that has been treated with a treating agent. The method includes the steps of placing the treatment device into an inlet of one of the tubes, and then actuating the vacuum of the central vacuum system so as to suck the device through the tube and into the vacuum so as to treat the tube as the object passes therethrough. One or more devices may be used for treating the network of tubes in the central vacuum system.

### BACKGROUND OF THE INVENTION

Central vacuum systems are commonly found in homes, and in particular are becoming popular in new home construction. The central vacuum system generally includes a plurality of PVC tubes or pipes extending through the house and connected to a vacuum canister located in the garage or basement. Each tube has an inlet valve to which a flexible hose can be connected by the user for vacuuming dust and dirt throughout the house, with the vacuumed debris being collected in the vacuum canister.

To date, there have been no products or methods available for treating the network of tubes in the central vacuum system. Since the tubes carry various matters, it is desirable to be able to clean, disinfect, and/or deodorize the tubes, as well as remove static electricity from the tubes and add fragrance to the tubes.

Systems have been developed for cleaning HVAC ducts. Generally, such systems include a mechanical object which is pulled or forced through the ducts in a direction opposite the normal airflow through the ducts. Such systems are typically complex, due to the variety of shapes and sizes of the ducts. For example, within any particular house or building, the HVAC ducts may range in size from 8 to 12 inches, or larger, and may have both round and rectangular shapes. Thus, the ducts do not have a consistent size throughout the HVAC system of a house. Also, the HVAC ducts generally are made of metal, with screws and other fasteners used to secure sections of the ducts together. Such screws or fasteners typically extend through the ducts into the interior thereof, thus presenting obstacles upon which cleaning devices may become snagged or otherwise blocked from passing through the ducts. Also, the air handler for the HVAC system typically does not have sufficient power to push or pull a cleaning object through the ducts, such that a separate power source must be provided. For all of these reasons, HVAC duct cleaning systems are not conducive for cleaning or treating the tubing network of a central vacuum system.

Accordingly, a primary objective of the present invention is a method of treating a central vacuum system.

A further objective of the present invention is the provision of an improved central vacuum system having a treatment device adapted to be sucked through the tubing network by the vacuum so as to treat the tubes.

Another objective of the present invention is the provision of a method for treating the tubing network of the central vacuum system using a cloth or towel which acts as a cleaning agent, deodorizing agent, disinfecting agent, a fragrance enhancement agent, and/or a static removal agent.

A further objective of the present invention is the provision of a treatment method for a central vacuum system which utilizes the vacuum of the system as a power source for moving a treatment agent through the tubing network.

Still another objective of the present invention is the provision of a treatment device for a central vacuum system which moves from the inlet valve of the system to the vacuum canister without a retrieval line.

Yet another objective of the present invention is the provision of a treatment method and device for a central vacuum system which can be recycled for repeated use in the system.

Another objective of the present invention is the provision of a treatment cloth, towel or device for a central vacuum system which is economical to manufacture and effective in use.

These and other objectives will become apparent from the following description of the invention.

### BRIEF SUMMARY OF THE INVENTION

A treatment method is provided for a central vacuum system having a plurality of tubes and a vacuum connected to the tubes. The method comprises the steps of placing a treatment cloth or device into an inlet of one of the tubes, and then actuating the vacuum to suck the treatment cloth through the tube and into the vacuum so as to treat the tube. The treatment may include cleaning, deodorizing, disinfecting, removal of static electricity, and/or adding fragrance to the tube. The treatment steps is repeated for additional tubes in the central vacuum system. Fresh treatment cloths may be used for each tube inlet, or the cloth may be recycled for multiple uses. The improvement to the central vacuum system according to the present invention comprises a treatment device, such as a cloth, towel other device, which can be sucked through the tubing network of the system upon actuation of the vacuum, thereby treating the tubes. The cloth or towel is treated with a cleaning agent, deodorizing agent, disinfecting agent, an aroma agent, and/or an anti-static agent. The cloth or towel is free from any retrieval line, such that the cloth or towel moves only in one direction through from the inlet valve of the tubes to the vacuum canister.

### BRIEF DESCRIPTION OF THE DRAWINGS

FIG. 1 is a schematic view of a house with a central vacuum system installed therein.

FIG. 2 is a schematic view showing a central vacuum system with treatment cloth according to the present invention for use in cleaning the tubes of the central vacuum system.

FIG. 3 is a view similar to FIG. 2 showing an alternative embodiment of a treatment device for use in treating the tubes of a central vacuum system.

### DETAILED DESCRIPTION OF THE PREFERRED EMBODIMENT

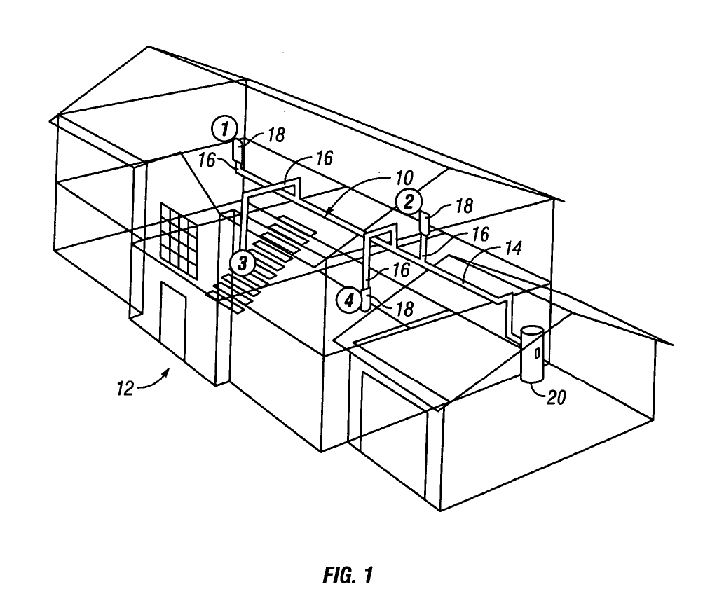

In FIG. 1, a central vacuum system 10 is shown installed in a house 12. The central vacuum system 10 includes a primary tube 14 with a series of branch tubes 16 extending there from. Each branch tube 16 has an inlet valve 18 at the terminal end. The primary tube 14 has a downstream end terminating in a vacuum canister 20. The canister 20 includes a power unit and a dust collector or receptacle. The tubes 14, 16 define a tubing network for the central vacuum system 10, which normally allows a person to clean all areas of the house 12 using a flexible hose (not shown) which can be selectively connected to any of the inlet valves 18.

The central vacuum system 10 described above is conventional, and does not constitute a part of the present invention.

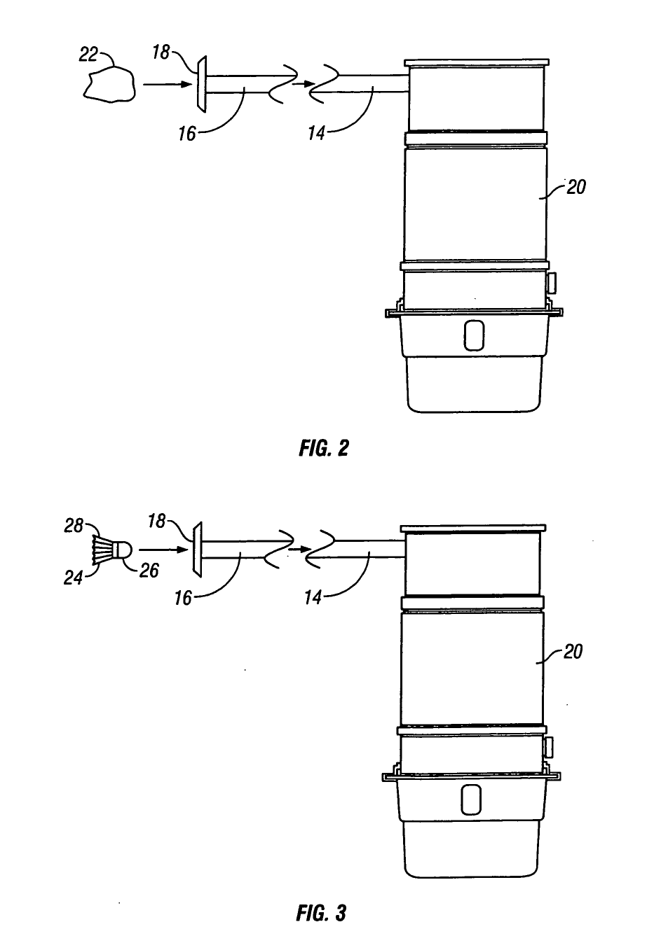

The invention is directed towards a method and device for treating the network of tubes 14, 16 of the central vacuum system. More particularly, as seen in FIG. 2, a treatment cloth or towel 22 may be introduced into the inlet valve 18 for suction through the tubes 14, 16 when the vacuum canister 20 is activated. Prior to passage through the tubing network, the cloth 22 is treated with one or more agents, such as a cleaning agent to clean the tubes 14, 16, a deodorizing agent to deodorize the tubes 14, 16, a disinfecting agent to disinfect the tubes 14, 16, an aroma agent to add fragrance to the tubes 14, 16, and/or an anti-static agent to remove static electricity from the tubes 14, 16. The cloth 22 is soft and flexible and substantially takes the shape of the interior of the tubes 14, 16 so as to engage the inside walls of the tubes 14, 16 as the cloth 22 is vacuumed through the tubing network. The cloth 22 easily passes through the tubes, including the elbows forming curves or bends in the tube through the network. The cloth 22 may be a single use cloth, or may be retrieved from the vacuum canister 20 and recycled for further use in the tubes 14, 16. If recycled, the cloth 22 may be re-treated with one or more of the treating agents.

As an alternative to the cloth 22, other treatment devices may be used in the tubes 14, 16. For example, as seen in FIG. 3, a shuttlecock or birdie-type treatment tool 24 may be introduced into the inlet valves 18 for passage through the tubing network upon actuation of the vacuum canister 20. The shuttlecock 24 includes a head 26 with fins or feathers 28 which engage the inside of the tubes 14, 16 as they shuttlecock 24 is vacuumed through the tubes.

As a further alternative, the treatment device may take other forms which are soft and pliable so as to easily move through the tubes 14, 16 through the force of the vacuum.

The method of treating the central vacuum system according to the present invention includes the steps of placing a treatment device, such as the cloth 22 or the shuttlecock 24, into an inlet of one of the branch tubes 16 of the central vacuum system tube network, and then actuating the vacuum to suck the treatment device through the selected tube 16 and the associated portion of the primary tube 14, and then into the vacuum canister 20, thereby treating the tubes 14, 16 as the treatment device passes therethrough. The steps can be repeated at each of the inlet valves 18 of the vacuum system, so that all of the tubes 14, 16 in the system are treated. The treatment may include cleaning, deodorizing, disinfecting, adding a fragrance and/or removing of static electricity. These treatment processes may be achieved using one or more treatment cloths 22 or other treatment devices.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of treating a central vacuum system having a plurality of tubes and a vacuum connected to the tubes, the method comprising:
(a) placing a treatment device into an inlet of one of the tubes;
(b) actuating the vacuum to suck the treatment device through the one tube and into the vacuum so as to treat the one tube.

2. The method of claim 1 further comprising repeating steps (a) and (b) for each of the tubes.

3. The method of claim 1 wherein the treatment device is a cloth.

4. The method of claim 1 wherein the treatment is cleaning the tubes of the central vacuum system.

5. The method of claim 1 wherein the treatment is deodorizing the tubes of the central vacuum system.

6. The method of claim 1 wherein the treatment is disinfecting the tubes of the central vacuum system.

7. The method of claim 1 wherein the treating is adding fragrance to the central vacuum system.

8. The method of claim 1 wherein the treatment is removing static electricity from the central vacuum system.

9. The method of claim 1 further comprising recycling the treatment device for use in treating other tubes in the central vacuum system.

10. The method of claim 1 further comprising moving the treatment device in only one direction through the one tube.

11. An improved central vacuum system having a plurality of tubes defining a tubing network, an inlet valve for each tube, and a vacuum canister connected to a terminal end of the tubing network, the improvement comprising:
a treatment device for sucking through the tubing network upon actuation of the vacuum so as to treat the tubes.

12. The improved central vacuum system of claim 11 wherein the treatment device is a cloth.

13. The improved central vacuum system of claim 12 wherein the cloth is treated with a cleaning agent to clean the tubes.

14. The improved central vacuum system of claim 12 wherein the cloth is treated with a deodorizing agent to deodorize the tubes.

15. The improved central vacuum system of claim 12 wherein the cloth is treated with a disinfecting agent to disinfect the tubes.

16. The improved central vacuum system of claim 12 wherein the cloth is treated with an aroma agent so as to add aroma to the tubes.

17. The improved central vacuum system of claim 12 wherein the cloth is treated with an anti-static agent to remove static electricity from the tubes.

18. The improved central vacuum system of claim 12 wherein the cloth is treated with an agent selected from a group consisting of a cleaner, a deodorizer, a disinfectant, a fragrance, and an anti-static.

19. The improved central vacuum system of claim 11 wherein the treatment device is recycled for use in multiple tubes.

20. The improved central vacuum system of claim 11 wherein the treatment device is free from any attachment residing outside the inlet valve when the device is sucked through the tube.
